(19) United States
(12) Patent Application Publication
(10) Pub. No.: US 2011/0003568 A1
(43) Pub. Date: Jan. 6, 2011

(54) APPARATUS AND METHOD FOR SEARCHING RADIO CHANNEL IN A PORTABLE TERMINAL

(75) Inventors: Han-Byul KIM, Seoul (KR); Yong-Ho YOU, Seoul (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/830,697

(22) Filed: Jul. 6, 2010

(30) Foreign Application Priority Data
Jul. 6, 2009 (KR) 10-2009-0060989

(51) Int. Cl. H04B 1/18

(52) U.S. Cl. 455/161.1

(57) ABSTRACT

An apparatus and method for searching for an improved radio broadcast in a portable terminal are provided. The apparatus includes a radio function performance unit. If an input for a radio broadcast channel search is detected while listening to a radio broadcast, the radio function performance unit changes from an original previously listened radio broadcast to a radio broadcast corresponding to the detected input. If the input for the radio broadcast channel search is released, the radio broadcast channel is restored to the original previously listened radio broadcast channel.

### PRIORITY

This application claims the benefit under 35 U.S.C. §119(a) of a Korean patent application filed in the Korean Intellectual Property Office on Jul. 6, 2009 and assigned Serial No. 10-2009-0060989, the entire disclosure of which is hereby incorporated by reference.

### BACKGROUND OF THE INVENTION

1. Field of the Invention

The present invention relates to an apparatus and method for searching for an improved radio broadcast in a portable terminal. More particularly, the present invention relates to an apparatus and method for, after searching for and finding a radio broadcast of a specific channel and changing an original radio broadcast to the found radio broadcast of the specific channel, restoring the changed radio broadcast being output to the original radio broadcast channel before the channel change.

2. Description of the Related Art

Recently, portable terminals have become a necessity to modern people. Service providers or system manufacturers have competitively developed products (or services) to differentiate from other service providers or system manufactures.

For example, the portable terminals provide a variety of services and have recently evolved into multimedia equipment for phone books, games, short messages, Electronic mail (E-mail) messages, morning wakeup calls, Moving Picture Experts Group (MPEG)-1 Audio Layer 3 (MP3) players, digital cameras, and a radio broadcast listening function.

More particularly, the radio broadcast listening function is used by many users for convenience of listening to a radio broadcast without a separate device capable of receiving a radio broadcast.

In order to listen to the radio broadcast, a user of a portable terminal providing the radio broadcast listening function needs to perform the following operation.

In general, the user carries out a method for searching for a radio broadcast channel by a frequency change button, a method for searching for a preset channel by a channel change button, and a method for either inputting a dial of a key pad to search for a channel corresponding to the dial or searching for a channel intended for listening in a preset list of channels.

However, when the user determines contents of a radio broadcast of a different frequency according to the above methods, a problem exists in that the user needs to re-select the listened radio broadcast, after searching for a radio broadcast of a specific channel while listening to a radio broadcast.

For example, if the user of the portable terminal intends to determine if a particular 107.7 MHz radio broadcast has begun while listening to a 95.9 MHz radio broadcast, the user has to periodically search for and switch to the 107.7 MHz radio broadcast while listening to the 95.9 MHz radio broadcast.

In a case where the 107.7 MHz radio broadcast is determined not to have begun, the user of the portable terminal has to again search for and switch back to the previously listened 95.9 MHz radio broadcast.

However, a problem exists in the above process due to an increased number of times of performing a radio channel search procedure which results in user inconvenience.

Therefore, a need exists for an apparatus and method for simplifying a radio channel search procedure.

### SUMMARY OF THE INVENTION

An aspect of the present invention is to address at least the above-mentioned problems and/or disadvantages and to provide at least the advantages below. Accordingly, an aspect of the present invention is to provide an apparatus and method for searching for an improved radio broadcast channel in a portable terminal.

Another aspect of the present invention is to provide an apparatus and method for reducing the number of times of performing a radio broadcast channel search procedure in a portable terminal.

A further aspect of the present invention is to provide an apparatus and method for, after changing a radio broadcast channel, restoring the changed radio broadcast channel to an original radio broadcast channel before the channel change and outputting the original radio broadcast channel in a portable terminal.

The above aspects are addressed by providing an apparatus and method for searching for a radio channel in a portable terminal.

In accordance with an aspect of the present invention, an apparatus for searching for a radio channel in a portable terminal is provided. The apparatus includes a radio function performance unit. If an input for radio broadcast channel search is detected while listening to a radio broadcast, the radio function performance unit processes to change from an original previously listened radio broadcast to a radio broadcast corresponding to the detected input and, if the input for radio broadcast channel search is released, restore the radio broadcast channel to the original previously listened radio broadcast channel.

In accordance with another aspect of the present invention, a method for searching for a radio channel in a portable terminal is provided. The method includes, if an input for a radio broadcast channel search is detected while listening to a radio broadcast, changing from an original previously listened radio broadcast to a radio broadcast corresponding to the detected input, and, if the input for radio broadcast channel search is released, restoring the radio broadcast channel to the original previously listened radio broadcast channel.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspect, features, and advantages of certain exemplary embodiments of the present invention will be more apparent from the following description taken in conjunction with the accompanying drawings, in which:

FIG. 1 is a block diagram illustrating a construction of a portable terminal for changing a radio channel according to an exemplary embodiment the present invention;

FIG. 2 is a flow diagram illustrating a radio channel change process in a portable terminal according to an exemplary embodiment the present invention;

FIG. 3A is a diagram illustrating a radio channel selection process in a portable terminal according to an exemplary embodiment of the present invention;

FIG. 3B is a diagram illustrating a radio channel change process in a portable terminal according to an exemplary embodiment of the present invention;

FIG. 3C is a diagram illustrating a radio channel change process in a general portable terminal according to an exemplary embodiment of the present invention; and

FIG. 3D is a diagram illustrating a radio channel restoration process in a portable terminal according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an apparatus and method for restoring an output radio broadcast to an original radio broadcast before a channel change, after outputting a radio broadcast corresponding to the channel change is output, in order to reduce the number of times of performing a radio broadcast channel search procedure in a portable terminal.

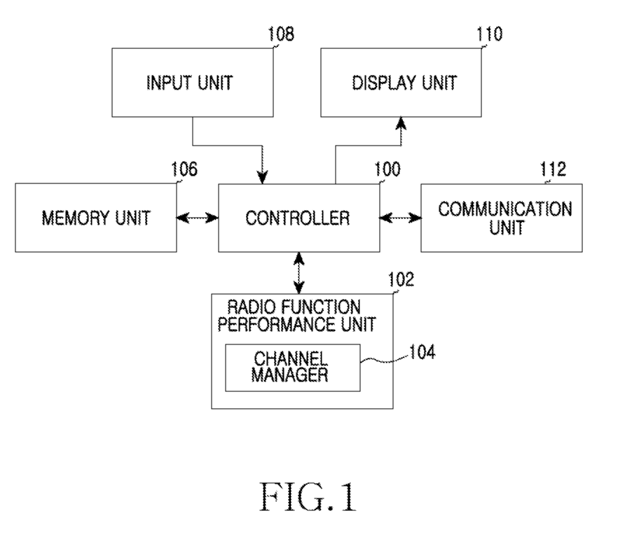

FIG. 1 is a block diagram illustrating a construction of a portable terminal for changing a radio channel according to an exemplary embodiment of the present invention. In the following description, the portable terminal denotes all portable devices such as a cellular phone, a Personal Communication System (PCS), a Personal Data Assistant (PDA), a mobile communication terminal supporting a radio reception function of a 4^{th} Generation (4G) broadband system, and the like. The following description is made by means of a construction of the mobile communication terminal.

Referring to FIG. 1, the portable terminal may include a controller 100, a radio function performance unit 102, a memory unit 106, an input unit 108, a display unit 110, and a communication unit 112. The radio function performance unit 102 may include a channel manager 104.

The controller 100 of the portable terminal controls a general operation of the portable terminal. For example, the controller 100 performs processing and control for voice telephony and data communication. In addition to a general function, after outputting a radio broadcast channel changed according to a channel change, if the controller 100 determines an input release for the channel change (i.e., does not listen to the radio broadcast of the changed channel), the controller 100 processes to restore the radio broadcast of the changed channel to an original radio broadcast channel output before the channel change.

The radio function performance unit 102 performs a radio function under control of the controller 100. If the radio function performance unit 102 requests the channel manager 104 to change a radio channel in the middle of a radio channel output, the radio function performance unit 102 allows the channel manager 104 to output a radio broadcast of the channel intended for the change. Thereafter, when the radio function performance unit 102 determines a release of a user's input for the channel change, the radio function performance unit 102 processes to restore the output radio broadcast to the original radio broadcast output before the channel change.

Under control of the radio function performance unit 102, the channel manager 104 processes to determine information of a radio channel selected by a user and a radio channel changed by the user, and outputs a radio broadcast of a corresponding channel. A function of the channel manager 104 may be implemented by the radio function performance unit 102 of the portable terminal. After changing the radio channel according to a radio channel search procedure, the channel manger 104 restores the changed radio channel to the original radio broadcast channel before the channel change. That is, an exemplary embodiment of the present invention determines a radio broadcast of a different channel while listening to a radio broadcast.

The memory unit 106 includes, for example, a Read Only Memory (ROM), a Random Access Memory (RAM), a flash ROM, and the like. The ROM stores a microcode (i.e., code) of a program for processing and controlling the controller 100 and the radio function performance unit 102 and a variety of reference data.

The RAM, a working memory of the controller 100, stores temporary data generated during execution of a variety of programs. The flash ROM stores a diversity of updateable depository data, such as a phone book, an outgoing message, an incoming message, and the like.

The input unit 108 includes numeral key buttons ‘0’ to ‘9’, a menu button, a cancel button (i.e., delete), an OK button, a talk button, an end button, an Internet button, navigation key buttons, a plurality of function keys such as a character input key, and the like. The input unit 108 provides key input data (e.g., a selection of a radio broadcast channel) corresponding to a key pressed by a user to the controller 100.

The display unit 110 displays state information generated during operation of the portable terminal, characters, a large amount of moving pictures, still pictures, and the like. The display unit 110 may be a color Liquid Crystal Display (LCD), an Active Mode Organic Light Emitting Diode (AMOLED), and the like. The display unit 110 may include a touch input device. If a touch input scheme is applied to the portable terminal, the display unit 110 may be used as an input device.

The communication unit 112 performs a function of transmitting/receiving and processing a radio signal of data input/output through an antenna (not illustrated). For example, in a transmission mode, the communication unit 112 processes original data through channel coding and spreading, converts the original data into a Radio Frequency (RF) signal, and transmits the RF signal. In a reception mode, the communication unit 112 converts a received RF signal into a baseband signal, processes the baseband signal through de-spreading and channel decoding, and restores the signal to original data.

A function of the radio function performance unit 102 may be implemented by the controller 100 of the portable terminal. However, it should be understood that an exemplary construction of the portable terminal is provided for the convenience of description and is not limited thereto. For example, construction of the portable terminal may also be such that all units are processed in the controller 100.

An apparatus has been described above for, after outputting a radio broadcast dependent on a channel change to provide information on a radio broadcast provided in a currently changed channel, restoring the output radio broadcast to the original radio broadcast before the channel change, in order to reduce the number of times of performing a radio broadcast channel search procedure. A method is described below for, after outputting a radio broadcast dependent on a channel change, restoring the output radio broadcast to the original radio broadcast before the channel change using the apparatus.

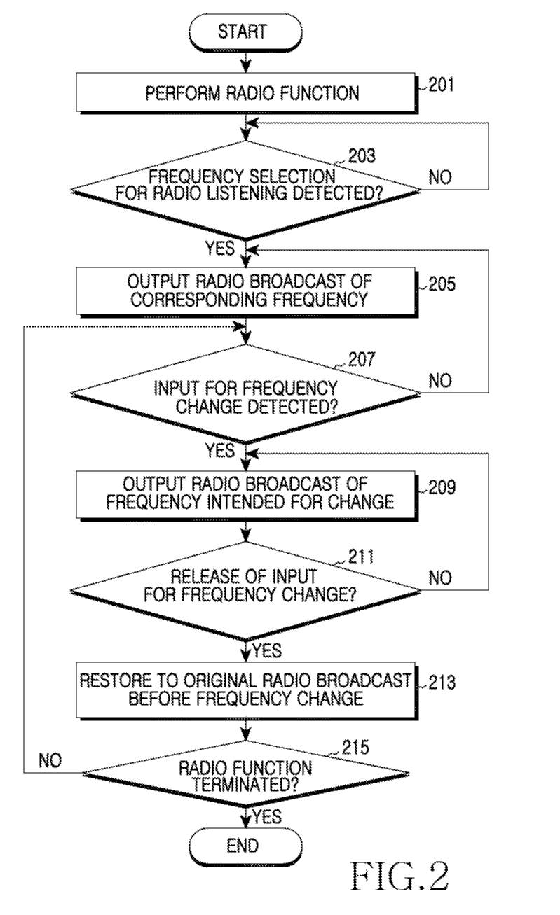

FIG. 2 is a flow diagram illustrating a radio channel change process in a portable terminal according to an exemplary embodiment of the present invention.

Referring to FIG. 2, the portable terminal defines a frequency of a radio broadcast in a key pad dial. In this state, a user of the portable terminal may select a dial and listen to a radio broadcast of a frequency corresponding to the dial. Also, when the user inputs a corresponding dial in order to listen to a radio broadcast of a different frequency while listening to the radio broadcast and releases the dial input, the portable terminal changes a frequency to the radio broadcast frequency corresponding to the dial input and, at the same time of the dial input release, restores a radio broadcast to a previously original listened radio broadcast. Accordingly, a dial input process of reselecting the previously original listened radio broadcast may be omitted, thus simplifying a radio broadcast channel search procedure.

In step 201, the portable terminal performs a radio function. Thereafter, the portable terminal determines a user's frequency selection for radio listening in step 203.

Here, the user's frequency selection for radio listening refers to selecting a dial corresponding to a frequency radio broadcast to which the user intends to listen among preset radio channels.

If the portable terminal does not detect the user's frequency selection for radio listening in step 203, the portable terminal returns to step 203.

On the other hand, if the portable terminal detects the user's frequency selection for radio listening in step 203, the portable terminal outputs a radio broadcast corresponding to the frequency selected by the user in step 205. The portable terminal determines a user's input for frequency change in step 207.

Here, while the user of the portable terminal listens to a radio broadcast, the user's input for frequency change refers to a dial input for searching for a radio broadcast of a different frequency or changing the radio broadcast to a radio broadcast of a different frequency.

If the portable terminal does not detect the user's input for frequency change in step 207, the portable terminal returns to step 205 and outputs the radio broadcast of the corresponding frequency.

On the other hand, if the portable terminal detects the user's input for frequency change in step 207, the portable terminal changes a radio broadcast to a radio broadcast frequency corresponding to a dial that a user inputs for frequency change and outputs the changed radio broadcast, thereby carrying out a user's radio channel change in step 209.

Thereafter, the portable terminal determines a release of the user's input for a frequency change in step 211.

Here, without listening to the changed radio broadcast of the frequency, the release of the user's input for frequency change is an input for selecting the previously original listened radio broadcast. The release of the user's input for frequency change may be a case where the user of the portable terminal releases the input carried out for the frequency change.

If the portable terminal does not detect the release of the user's input for the frequency change in step 211, the portable terminal outputs the changed radio broadcast of the frequency in step 209.

On the other hand, when the portable terminal detects the release of the user's input for the frequency change in step 211, the portable terminal restores the radio broadcast of the frequency changed by the user to the original radio broadcast listened to before the frequency change in step 213. In an exemplary implementation, a radio channel search is, for example, described regarding restoring a radio channel, after a radio channel change, to an original radio broadcast radio channel listened to before the channel change according to a user's input. However, according to the user's input, the radio channel may be changed and then the changed radio channel may be selected again.

For example, if the user of the portable terminal determines a radio broadcast ‘B’ intended for listening while currently listening to a radio broadcast ‘A’, if there is a dial input corresponding to the radio broadcast ‘B’, the portable terminal outputs the radio broadcast ‘B’. If the radio broadcast ‘B’ being output is not a radio broadcast that the user intends for listening, the user will release the dial being input that corresponds to the radio broadcast ‘B.’ Thus, in an exemplary implementation, the portable terminal restores the radio broadcast ‘B’ to an original radio broadcast ‘A’ that is output before outputting the radio broadcast ‘B’.

Thereafter, the portable terminal determines whether the radio function is terminated in step 215.

If it is determined that the radio function is not terminated in step 215, the portable terminal returns to step 207.

On the other hand, if it is determined that the portable terminal terminates the radio function in step 215, the portable terminal terminates the process.

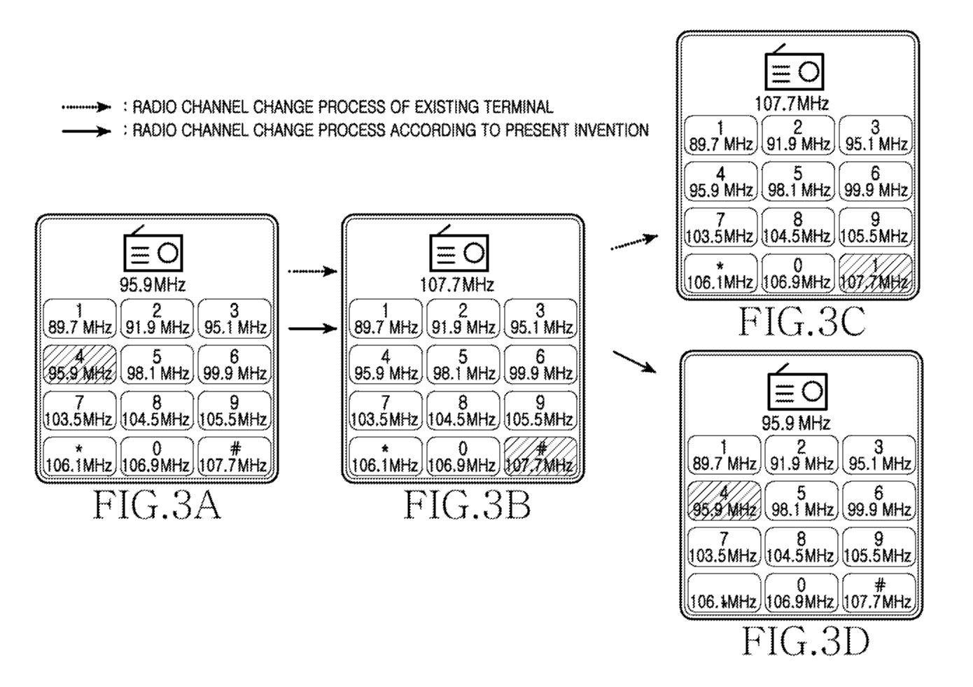

FIGS. 3A-3D are diagrams illustrating a radio channel change process in a portable terminal according to an exemplary embodiment of the present invention.

Referring to FIGS. 3A-3D, shadowing for an input unit of the portable terminal denotes that a channel of a radio broadcast is selected by a user of the portable terminal.

FIG. 3A is a diagram illustrating a radio channel selection process in a portable terminal according to an exemplary embodiment of the present invention.

Referring to FIG. 3A, the portable terminal defines a frequency of a radio broadcast in a dial of a key pad. In this state, a user of the portable terminal may select a radio channel on a dial and listen to a radio broadcast corresponding to the dial.

As illustrated in FIG. 3A, when the portable terminal defines a 95.9 MHz radio broadcast in a dial ‘4’, the user of the portable terminal may listen to the 95.9 MHz radio broadcast by selecting and inputting the dial ‘4’.

FIG. 3B is a diagram illustrating a radio channel change process in a portable terminal according to an exemplary embodiment of the present invention.

Referring to FIG. 3B, when a user of the portable terminal intends to listen to a different radio broadcast while listening to the radio broadcast selected in FIG. 3A, the portable terminal selects and inputs a dial corresponding to a radio broadcast intended for change, thereby changing the radio broadcast being output into the radio broadcast corresponding to the input dial.

More specifically, as illustrated in FIG. 3B, if the user of the portable terminal intends to listen to a 107.7 MHz radio broadcast while listening to a 95.9 MHz radio broadcast selected in FIG. 3A, the user may select and input a dial ‘#’ corresponding to the 107.7 MHz radio broadcast, changing the 95.9 MHz radio broadcast into the 107.7 MHz radio broadcast.

FIG. 3C is a diagram illustrating a radio channel change process in a general portable terminal according to an exemplary embodiment of the present invention.

Referring to FIG. 3C, when a portable terminal changes a radio broadcast through a dial input as illustrated in FIG. 3B, the portable terminal outputs a radio broadcast corresponding to a recently input dial. If the changed radio broadcast is not a target radio broadcast that a user of the portable terminal intends to change to or a broadcast program of a corresponding frequency does not start, the user intends to listen to the radio broadcast previously listened. At this time, the user changes from the changed radio broadcast to the previously listened radio broadcast by inputting a dial corresponding to the previously listened radio broadcast before the channel change, while listening to the changed radio broadcast. That is, although the user of the portable terminal releases the dial input in FIG. 3B, the portable terminal continuously outputs the changed radio broadcast. Accordingly, when the user changes the changed radio broadcast to the previously listened radio broadcast, the user has to again select and input the dial selected in FIG. 3A.

FIG. 3D is a diagram illustrating a radio channel restoration process in a portable terminal according to an exemplary embodiment of the present invention.

Referring to FIG. 3D, if a radio broadcast changed through a dial input as illustrated in FIG. 3B is not a target radio broadcast that a user of the portable terminal intends to change to or a broadcast program of a corresponding frequency does not start, the user intends to listen to a previously listened radio broadcast. At this time, in an exemplary implementation, the user of the portable terminal releases the dial input for the radio broadcast change, the portable terminal restores a frequency of the changed radio broadcast to an original frequency corresponding to the previously listened radio broadcast before the channel change.

Although not illustrated, if the user determines that the changed radio broadcast is a target radio broadcast intended to change to, the portable terminal may change from the original radio broadcast to the target radio broadcast, if there is a continuous input of a corresponding dial.

A comparison of the radio channel change process between the portable terminal and the portable terminal is described in detail below.

In the radio channel change process of the portable terminal, if the portable terminal searches for a different radio channel while listening to a radio broadcast, the portable terminal outputs the searched channel. Thus, in order for a user to listen to a radio broadcast channel before a channel change, the portable terminal performs a radio channel search procedure again. The radio channel change process of the portable terminal may be carried out in sequence of FIG. 3A→FIG. 3B→FIG. 3C→FIG. 3A.

Also, in the radio channel change process of the portable terminal, after searching for a different radio channel while listening to the radio broadcast, the portable terminal returns from the searched different radio channel to the original radio channel before the search, thus simplifying the radio channel search procedure. The radio channel change process of the portable terminal according to the exemplary embodiment of the present invention may be carried out in sequence of FIG. 3A→FIG. 3B→FIG. 3D.

As described above, exemplary embodiments of the present invention restores a radio broadcast, changed according to a channel change, to the original radio broadcast before the channel change, and outputs the original radio broadcast in order to reduce the number of times a radio broadcast channel search procedure is performed in a portable terminal. Accordingly, a radio broadcast channel search procedure is simplified by not selecting the listened radio broadcast again after searching for the radio broadcast of the specific channel in a portable terminal.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for searching for a radio channel in a portable terminal, the apparatus comprising:
a radio function performance unit for, if an input for a radio broadcast channel search is detected while listening to a radio broadcast, processing to changing from an original previously listened radio broadcast to a radio broadcast corresponding to the detected input and, if the input for the radio broadcast channel search is released, restoring the radio broadcast channel corresponding to the original previously listened radio broadcast channel.

2. The apparatus of claim 1, wherein, after the changing from the previously listened radio broadcast to the radio broadcast corresponding to the detected input, if an input for channel selection is detected, the radio function performance unit sets the radio broadcast corresponding to the detected input to the original previously listened radio broadcast.

3. The apparatus of claim 1, wherein the detecting of the input for the radio broadcast channel search comprises maintaining an input of an input button in which a channel of a radio broadcast intended to be searched is defined.

4. The apparatus of claim 3, wherein the releasing of the input for the radio broadcast channel search comprises releasing the input of the input button in an input state in which the channel of the radio broadcast intended to be searched is defined.

5. The apparatus of claim 4, wherein the input button is included in a key pad.

6. The apparatus of claim 5, wherein the portable terminal receives a dial input of the key pad corresponding to a frequency of the radio broadcast.

7. The apparatus of claim 2, wherein the detecting of the input for channel selection comprises continuously performing the input for the radio broadcast channel search.

8. A method for searching for a radio channel in a portable terminal, the method comprising:
if an input for a radio broadcast channel search is detected while listening to a radio broadcast, changing from an original previously listened radio broadcast to a radio broadcast corresponding to the detected input; and
if the input for the radio broadcast channel search is released, restoring the radio broadcast channel corresponding to the original previously listened radio broadcast channel.

9. The method of claim 8, further comprising, after the changing from the previously listened radio broadcast to the radio broadcast corresponding to the detected input, if an input for channel selection is detected, setting the radio broadcast corresponding to the detected input to the original previously listened radio broadcast.

10. The method of claim 8, wherein the detecting of the input for the radio broadcast channel search comprises maintaining an input of an input button in which a channel of a radio broadcast intended to be searched is defined.

11. The method of claim 10, wherein the releasing of the input for the radio broadcast channel search comprises releasing the input of the input button in an input state in which the channel of the radio broadcast intended to be searched is defined.

12. The method of claim 11, wherein the input button is included in a key pad.

13. The method of claim 12, wherein the portable terminal receives a dial input of the key pad corresponding to a frequency of the radio broadcast.

14. The method of claim 9, wherein the detecting of the input for channel selection comprises continuously performing the input for the radio broadcast channel search.
